(19) United States
(12) Patent Application Publication
(10) Pub. No.: US 2025/0377476 A1
(43) Pub. Date: Dec. 11, 2025

(54) Weight Warden Digital Synchronous Signal Detection Algorithm

(71) Applicant: ZEBRA TECHNOLOGIES CORPORATION, Lincolnshire, IL (US)

(72) Inventors: Lenworth E. Anderson, Bayside, NY (US); Joseph F. DiGregorio, Seaford, NY (US)

(21) Appl. No.: 18/737,944

(22) Filed: Jun. 7, 2024

(51) Int. Cl. G01V 8/14; G01G 19/414; G01G 21/22; G01G 23/18; G06K 7/14

(52) U.S. Cl. CPC G01V 8/14; G01G 19/4144; G01G 21/22; G01G 23/18; G06K 7/1413

(57) ABSTRACT

Techniques for improving accuracy of output of an imaging system for detecting an object between a light source and a reflector are provided. The techniques include timing a sampling of a measurement of an intensity of a reflection of a light beam based on an expected processing delay associated with the imaging system circuitry. Particularly, the sampling may be timed to occur when the expected reflection intensity is at or near its greatest magnitude, so as to improve a signal-to-noise (SNR) ratio between the expected reflection and other light manipulation (noise) introduced by an environment surrounding the imaging system. An imaging system incorporating techniques herein may be implemented, for example, in a bioptic barcode reader in a retail environment to improve object detection and weight measurement accuracy by the bioptic barcode reader.

### FIELD OF THE DISCLOSURE

The present disclosure relates to imaging techniques, and more particularly, to improving signal-to-noise ratio and accuracy associated with detection of an object in a path between a light source and an optical reflector.

### BACKGROUND

Imaging systems detect the presence of an object in a path between a light source and an optical reflector positioned distally from the light source, based on whether a sensor detects a reflection of a beam of light emitted by the light source (e.g., an infrared beam). Generally, when the sensor does not detect the reflection at an expected magnitude, the imaging system identifies that an object is likely positioned in the path between the light source and the reflector (with the object blocking or scattering the emitted light beam to prevent the full reflection from reaching the sensor). Inversely, when the sensor does detect the reflection at substantially the expected magnitude, the imaging system identifies that an object is not positioned in the path. These imaging systems can be implemented, for example, in bioptic barcode readers for retail environments, using reflection detection to determine whether a customer has properly placed an object on a platter for weighing (with detection of the object in the path indicating an “off-platter” condition that may compromise an accurate weight measurement).

Accurate detection of the object in the light path requires obtaining a reliable measurement of the magnitude of the reflected light. However, the environment surrounding an imaging system can impede a reliable measurement by introducing noise, e.g., from atmospheric conditions or reflective clothing or other reflective elements in the nearby environment introducing additional sources of reflection or scattering of light. When a signal-to-noise (SNR) ratio of the actual reflection to the environmental noise is decreased, false positive or false negative object detection events become more likely. In the example bioptic barcode reader implementations, inaccurate object detection events impede the checkout process, e.g., by falsely indicating that a user has mispositioned an object on the platter, or by producing an inaccurate weight measurement of the object when the system fails to detect that the object is partially off the platter).

### SUMMARY

In some aspects, a system is provided. The system may include a light source configured to emit a light beam at a first time to impinge upon a reflector positioned distally from the light source, a sensor configured to receive a reflection of the emitted light beam from the reflector, and a controller. The controller may be configured to (1) obtain an indication of a predefined measurement delay associated with a detection of a particular intensity of the reflection of the emitted light beam via the sensor, (2) measure a reflection intensity of the received reflection at a second time identified based on the measurement delay and the first time, (3) compare the measured reflection intensity to an expected reflection intensity for the second time, and/or (4) determine whether an object is positioned in a path between the light source and the reflector based on the comparing of the measured reflection intensity at the second time to the expected reflection intensity.

In some aspects, the system may further include a weigh platter having a surface extending in a transverse plane, the weigh platter being configured to measure a weight of an object on the weigh platter, wherein the light source is configured to emit the light beam along the transverse plane. The controller may further be configured to (5) determine that an object is on the weigh platter based on the measured weight of the object, and (6) determine an off-platter condition based on the comparing of the measured reflection intensity to the expected reflection intensity when the object is on the weigh platter, and/or (7) cause a visual indication of the off-platter condition to be provided to a user via one or more output devices.

In some aspects, the particular intensity is a peak intensity of the reflection of the emitted light beam, and the expected reflection intensity for the second time is an expected peak reflection intensity.

In some aspects, the controller stores the indication of the predefined measurement delay at a controller memory.

In some aspects, the controller is further configured to (5) sample the reflection intensity by measuring the reflection intensity at a plurality of time intervals after the first time, and (6) use the reflection intensity measured at the second time and not at other ones of the plurality of time intervals to determine whether an object is positioned in the path between the light source and the reflector.

In some aspects, the controller is configured to determine whether an object is positioned in the path by determining whether a difference between the measured reflection intensity and the expected reflection intensity is equal to or greater than a nonzero threshold value.

In some aspects, the controller is further configured to, in response to determining that an object is positioned in the path between the light source and the reflector based on a difference between the measured reflection intensity and the expected reflection intensity, the controller is further configured to determine a further one or more properties of the object based on the difference.

In some aspects, the controller further includes a capacitor configured to be energized via the receiving of the reflection of the emitted light beam, wherein the controller is configured to cause the capacitor to be de-energized after the receiving of the reflection. The second time may be a time associated with an expected negative voltage during the de-energizing of the capacitor, and wherein the controller is configured to measure the reflection intensity by measuring a negative voltage of the capacitor at the second time.

In some aspects, a method is provided. The method may include (1) at a first time, emitting a light beam via a light source to impinge upon a reflector positioned distally from the light source, (2) receiving a reflection of the emitted light beam via a sensor, (3) via a controller, obtaining an indication of a predefined measurement delay associated with a detection of a particular intensity of the reflection of the emitted light beam via the sensor, (4) via the controller, measuring a reflection intensity of the received reflection at a second time identified based on the measurement delay and the first time, (5) via the controller, comparing the measured reflection intensity to an expected reflection intensity for the second time, and/or (6) via the controller, determining whether an object is positioned in a path between the light source and the reflector based on the comparing of the measured reflection intensity at the second time to the expected reflection intensity.

In some aspects, the method further includes, via a weigh platter having a surface extending in a transverse plane, measuring a weight of an object on the weigh platter, wherein the light source emits the light beam along the transverse plane. In these embodiments, the method may still further include, via the controller, (7) determining that an object is on the weigh platter based on the measured weight of the object, (8) determining an off-platter condition based on the comparing of the measured reflection intensity to the expected reflection intensity when the object is on the weigh platter, and/or (9) causing a visual indication of the off-platter condition to be provided to a user via one or more output devices.

In some aspects, the particular intensity is a peak intensity of the reflection of the emitted light beam, and the expected reflection intensity for the second time is an expected peak reflection intensity.

In some aspects, the controller stores the indication of the predefined measurement delay at a controller memory.

In some aspects, the method may further include, via the controller, (7) sampling the reflection intensity by measuring the reflection intensity at a plurality of time intervals after the first time, and/or (8) using the reflection intensity measured at the second time and not at other ones of the plurality of time intervals to determine whether an object is positioned in the path between the light source and the reflector.

In some aspects, determining whether an object is positioned in the path is based on determining whether a difference between the measured reflection intensity and the expected reflection intensity is equal to or greater than a nonzero threshold value.

In some aspects, the method may further include via the controller and in response to determining that an object is positioned in the path between the light source and the reflector based on a difference between the measured reflection intensity and the expected reflection intensity, determining a further one or more properties of the object based on the difference.

In some aspects, the method may further include (7) energizing a capacitor using energy from the receiving of the reflection of the emitted light beam, and/or (8) de-energizing the capacitor after the receiving of the reflection. The second time may be a time associated with an expected negative voltage during the de-energizing of the capacitor, and wherein the measuring of the reflection intensity is based on measuring a negative voltage of the capacitor at the second time.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts a front perspective view of an example imaging system in a bioptic barcode reader, in accordance with various embodiments described herein.

FIG. 2 depicts a front perspective view of the bioptic barcode reader of FIG. 1, having hardware configured to emit and reflect a light beam.

FIG. 3 depicts a top view of the bioptic barcode reader of FIG. 2, with further hardware associated with measuring intensity of the reflection of the light beam.

FIG. 4 depicts example properties of a light beam emitted by a light source and detected by a sensor after reflection, in accordance with various embodiments described herein.

FIG. 5 depicts an example graph of time-based detection of a reflection, in accordance with various embodiments described herein.

FIG. 6 depicts another example graph of time-based detection of a reflection, in accordance with various embodiments described herein.

FIG. 7 depicts a block diagram of an example logic circuit for implementing example methods and/or operations described herein.

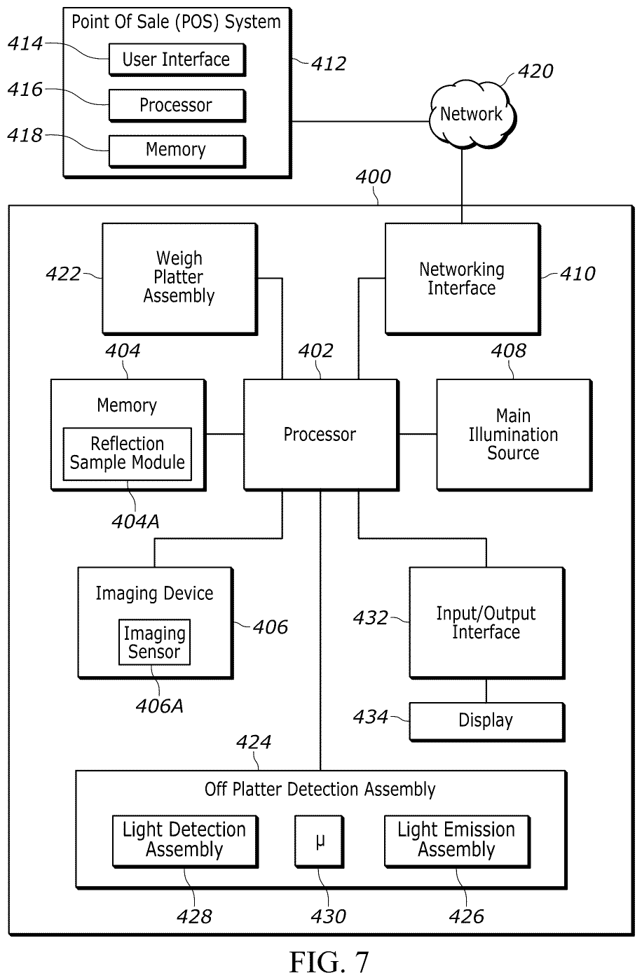

FIG. 8 depicts a block diagram of an example method, in accordance with various embodiments described herein.

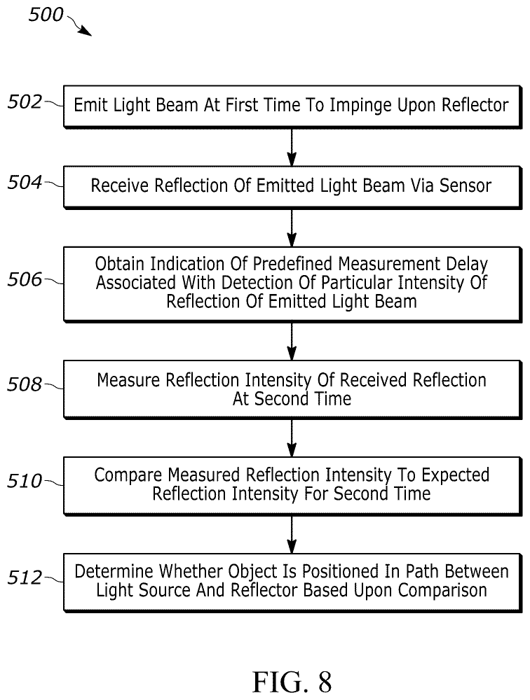

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present disclosure describes systems and methods that can improve the signal to noise ratio (SNR) associated with measurement of an intensity of a reflection of a beam (e.g., infrared (IR) beam) emitted by a light source toward a reflector in an imaging systems. Particularly, a measurement of the reflection intensity may be timed to take place synchronously with an expected peak reflection intensity (or other substantial intensity, e.g., near-peak) as observed via a sensor, accounting for a measurement delay of the imaging system. By improving the SNR, a system utilizing the intensity measurement may produce more reliable determinations of whether or not an object is positioned in a path of the light beam between the light source and the reflector.

Although some example implementations described with respect to the figures will particularly include the imaging system implemented in a bioptic barcode reader for detecting products (e.g., in a retail environment), it should be appreciated that systems and methods of this disclosure may be implemented in various other contexts. For example, imaging systems described herein may be implemented in various environments that may require the scanning and/or weighing of objects, and particularly where proper positioning of the object is elemental to effective scanning and/or weighing of the object. Such environments could include, as just one example, a warehouse and/or shipping environment. Moreover, systems and methods of this disclosure may be implemented in still other contexts that involve detecting presence of an object (and/or a property of the object) based on measured intensity of a beam emitted by a light source (e.g., to determine composition, viscosity, or opacity of a fluid, where the imaging system positions the light source and reflector on opposite sides of a vessel containing the fluid).

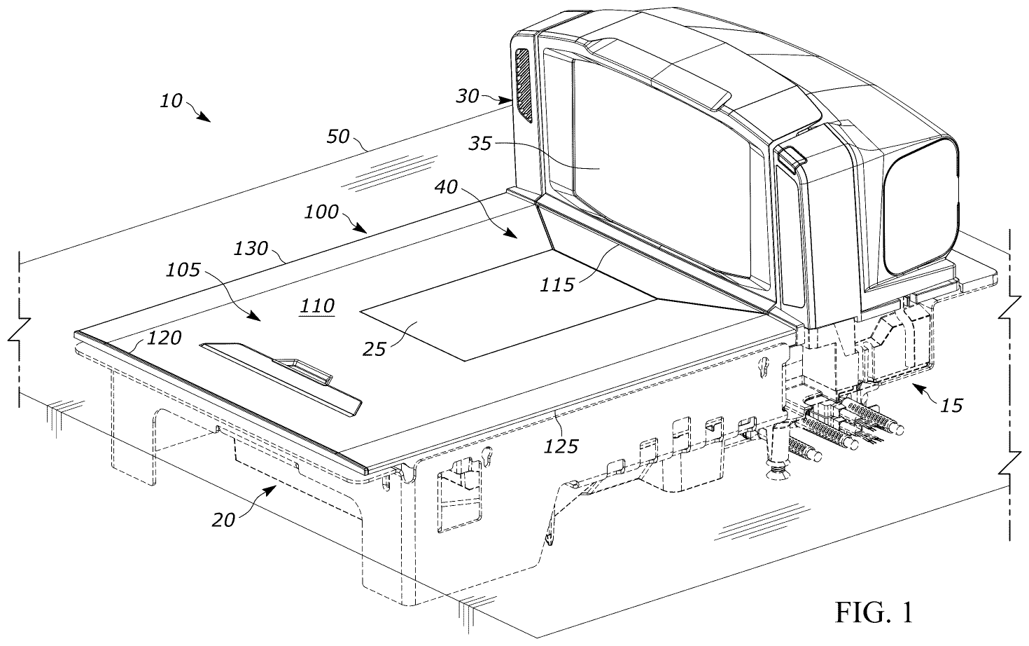

In FIG. 1, an example imaging system 10, in the form of a bioptic barcode reader, is shown configured to be supported by a workstation 50, such as a checkout counter at a point-of-sale (POS) of a retail store. The imaging system 10 has a housing 15 that houses a weigh platter assembly 100 and includes a lower housing 20 and an upper housing 30 that extends above the lower housing 20. The upper housing 30 includes a generally vertical window 35 to allow a first set of optical components positioned within the housing 15 to direct a first field-of-view through the vertical window 35. In addition, if the imaging system 10 is a bioptic barcode reader, the imaging system 10 will include a generally horizontal window 25, which in the example shown is positioned in a weigh platter 105 of the weigh platter assembly 100 to allow a second set of optical components positioned within the housing 15 to direct a second field of view through the horizontal window 25. The first and second fields of view intersect to define a product scanning region 40 of barcode reader 10 where a product can be scanned for sale at the POS.

The weigh platter assembly 100 of the imaging system 10 includes a weigh platter 105 and is configured to measure the weight of an object placed on the weigh platter 105. The weigh platter 105 has a surface 110 that is generally parallel to a top surface of workstation 50 and extends in a first transverse plane, a proximal edge 115, a distal edge 120, a first lateral edge 125, and a second lateral edge 130. In the example shown, the proximal edge 115 is adjacent upper housing 30 and would be the edge furthest from a user of the weigh platter assembly 100 and/or imaging system 10. First and second lateral edges 125, 130 extend non-parallel to the proximal edge 115. The distal edge 120 is opposite the proximal edge 115, and would be the edge closest to the user (e.g., scanning and/or weighing a product(s) at the POS). The distal edge 120 extends non-parallel to the first and second lateral edges 125, 130. In the example shown, the weigh platter 105 is generally rectangular and the first and second lateral edges 125, 130 are perpendicular to the proximal edge 115, and the distal edge 120 is perpendicular to the first and second lateral edges 125, 130 and parallel to the proximal edge 115.

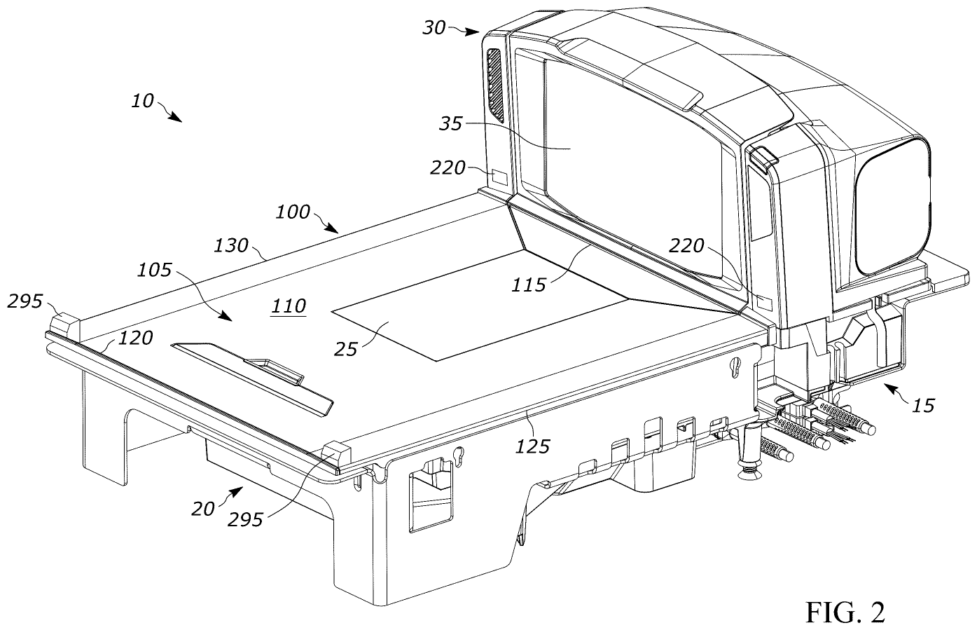

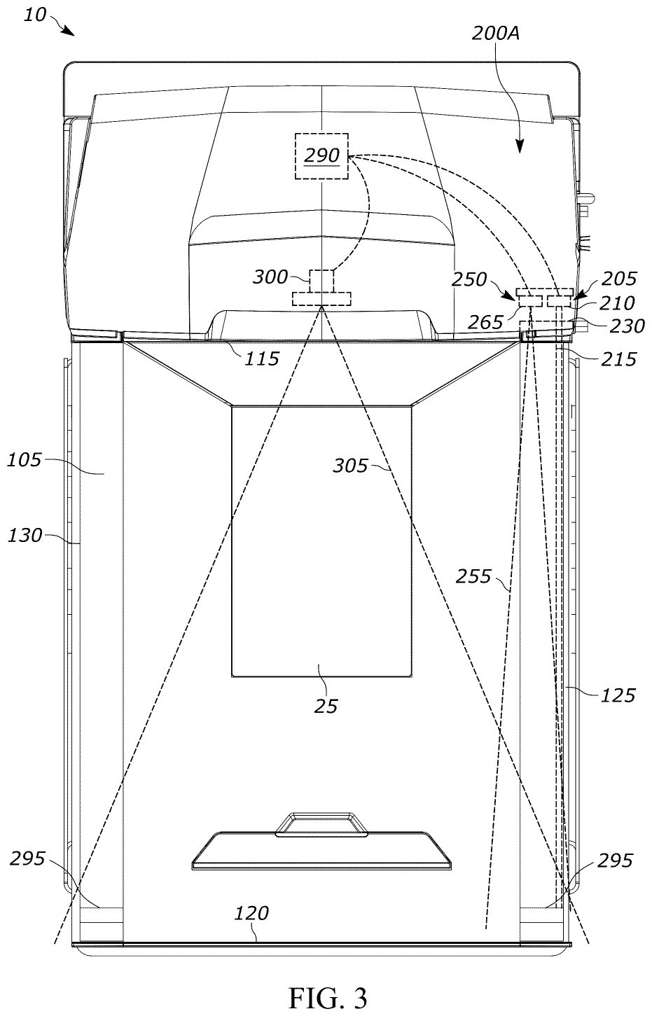

Referring to FIGS. 2 and 3, which depict front and top views respectively of an example embodiment of the imaging system 10, the imaging system 10 includes an example off-platter detection assembly 200A. The off-platter detection assembly 200A generally includes a light emission assembly 205, a light detection assembly 250, a controller 290 in communication with the light emission assembly 205 and the light detection assembly 250, and a retroreflector 295 positioned at the distal edge 120 of the weigh platter 105, opposite the light emission assembly 205. For simplicity, only a single light emission assembly 205, light detection assembly 250, and retroreflector 295 along the first lateral edge 125 are described herein, however, it will be understood that the off-platter detection assembly 200A can also include a second light emission assembly, a second light detection assembly, and a second retroreflector aligned along second lateral edge 130 of weigh platter 105 to detect objects that extend over second lateral edge 130, opposite first lateral edge 125. Thus, the imaging system 10 can detect a product on or past either the first or second lateral edges 125/130.

In the example shown in FIGS. 2 and 3, the light emission assembly 205 is located within the upper housing 30 of the housing 15, has a light source 210, and is configured to emit a light 215 through a window 220 and away from the proximal edge 115, towards the distal edge 120 and retroreflector 295, and along the first lateral edge 125 of the weigh platter 105. The light source 210 could be an LED that is focused into a narrow beam, similar to an aiming dot used in scanners, a focused laser beam, etc., and the light 215 could be pulses of light (such as in a light imaging, detection, and ranging (LIDAR) system) or a continuous light beam and could be on the infrared (IR) wavelength, visible light wavelength, or any wavelength desired. The retroreflector 295 can be made of a material and/or color that reflects a wavelength of the light 215 back towards the proximal edge 115 of the weigh platter 105. The retroreflector 295 may be a passive reflector. In some examples, the retroreflector 295 may be replaced with an active reflector, for example, a reflector assembly have its own light detection assembly and light emission assembly, where the active reflector receives an emission from the light emission assembly 205 and generates a return light emission directed at the light detection assembly 250.

The light detection assembly 250 can also be located within the housing 15, behind the window 220, and has a field-of-view 255 that extends from the proximal edge 115 to at least the distal edge 120 and along the first lateral edge 125. The light detection assembly 250 has a light sensor 265 and is configured to detect the light 215, from one or more pulses of light or a continuous infrared light beam from the light emission assembly 205, that is reflected from the retroreflector 295 or from an object that extends across a path of the light 215, and therefore off of the weigh platter 105, towards the proximal edge 115 and within the field-of-view 255. The light sensor 265 can be positioned below or beside the light source 210, and could also be located on the same printed circuit board as the light sensor 265.

In the illustrated example, the imaging system 10 includes the controller 290 in communication with the light source 210 of the light emission assembly 205 and the light sensor 265 of the light detection assembly 250. The controller 290 may be configured to receive a light detection signal from the light detection assembly 250. For example, if the light emission assembly 205 is configured to emit a continuous light beam, such as a continuous infrared (IR) light beam, from the light source 210, the light detection signal from the light detection assembly 250 could be a signal strength of the reflected light from the retroreflector 295 or object that is detected by the light sensor 265.

In an off-platter detection mode, the controller 290 can be configured to determine if an object extends across the first lateral edge 125 and off of the weigh platter 105 by comparing the light detection signal to a first signal threshold and determining if the light detection signal is less than the first signal threshold. For example, the first signal threshold could be 10 percent of a calibration signal, which would be the signal strength of the light reflected from the retroreflector 295 detected by light detection assembly 250 without anything (e.g., an object, dirt, debris, etc.) impeding the path of the light 215 from the light source 210 to the retroreflector 295 and from the retroreflector 295 to the light sensor 265. The calibration signal for off-platter detection can be set at the factory or on-site during calibration of the imaging system 10. If the light detection signal is greater than the first signal threshold, this indicates that there is no object extending across the first lateral edge 125 between the proximal edge 115 and the distal edge 120. If the light detection signal is less than the first signal threshold, in the off-platter detection mode, this indicates that there is an object extending across the first lateral edge 125 between the proximal edge 115 and the distal edge 120 and, if the controller 290 determines that the light detection signal is equal to or less than the first signal threshold, the controller 290 can be configured to execute a first event, such as providing a visual and/or audio alert through the imaging system 10 or otherwise through the POS system, preventing the weigh platter assembly 100 from measuring a weight of a product placed on the weigh platter 105, and/or preventing communication of the weight measured by the weigh platter assembly 100 with the POS system.

Where detection of the product across the first lateral edge 125 has been described, same or similar operations may occur with respect to the second lateral edge 130. For example, another light assembly 205 may be provided along the second lateral edge 130 at or near the proximal edge 115 of the weigh platter 105, and may provide its own respective light detection assembly 250 to operate in a manner to that described above to detect a product on or across the second lateral edge 250, emitting another, second light 215 toward a second retroreflector 295 positioned along the second lateral edge 130 at or near the distal edge 120. The controller 290 may be configured to communicate with the second light emission assembly 205 and the second light detection assembly 250 to detect the product along the second lateral edge 230. In some embodiments, the controller 290 may be a central controller configured to communicate with respective subcontrollers that control operations of the respective light emission and detection assemblies 205/250 (e.g., a first subcontroller configured to communicate with the first light emission assembly 205 and first light detection assembly 250, and a second controller configured to communicate with the second light emission assembly 205 and second light detection assembly 250). For simplicity, subsequent discussion will focus on emission and detection of light along the first lateral edge 125, but is should be appreciated that same or similar techniques may additionally or alternatively be implemented with respect to separate light emission and detection along the second lateral edge 130.

The imaging system 10 may include an imaging device 300, such as a color camera, positioned within the housing 15, preferably within the upper housing 30 and proximate a top portion of the vertical window 35, and in communication with the controller 290. The imaging device 300 can have a field of view (FOV) 305 that encompasses the distal edge 120 of the weigh platter 105 and the retroreflector 295, and the controller 290 can be configured to analyze images captured by the imaging device 300 and determine if an object is in the FOV 305. Further, the imaging system 10 may include a display 302 positioned within the upper housing 30, visible through the vertical window 35. That display 302 may be a small digital display, angled relative to a normal of the vertical window 35, to not be visible to a user during normal object scanning, but rather only visible to a user looking into the window 35 from a particular angular direction. The display 302 may, for example, display information indicative of measured reflection intensity and/or off-platter conditions described herein.

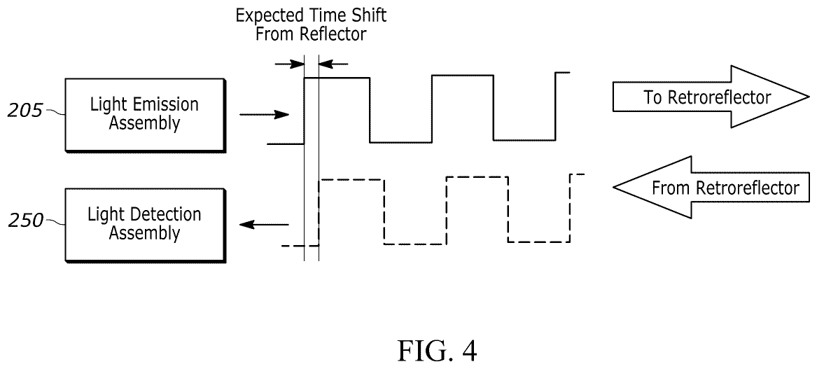

In view of FIGS. 1-3, FIG. 4 illustrates an example travel of the light 215 from the light emission assembly 205 (e.g., from the light source 210) to the retroreflector 295 and back to the light detection assembly 250 (e.g., to the light sensor 265). In this example, the light emission assembly 205 emits pulses of light, e.g., based on signals provided from the controller 290 by way of a digital-to-analog converter between the controller 290. As depicted in FIG. 4, this pulsing light as emitted by the light emission assembly takes the form of a square wave, with peaks and valleys of emitted light intensity representing the light emission assembly 205 in “on” and “off” states, respectively. The light pulses are emitted in the direction of the retroreflector 295 and, in a scenario where no object is positioned in the path between the light emission assembly 205 and the retroreflector 295, a reflection of each pulse of the light 215 travels from the retroreflector 295 to the light detection assembly 250. Although the emission of the light 215 takes the form of the square wave, the environment around the imaging system 10 distort the light 215 such that the reflection arriving back to the light detection assembly 250 more closely resembles a sinusoidal wave, as will be described with respect to figures later in this disclosure. The light detection assembly 250 may receive the reflection and provide an indication of the intensity (magnitude) thereof to the controller 290, e.g., as an analog voltage or as a digital signal by way of an analog-to-digital converter.

For each pulse, the real time of emission of the pulse (e.g., exiting the light source 210) is offset from the real arrival of the pulse to the light detection assembly (e.g., arriving at the sensor 265) by a first delay (or “time shift”). This first delay is small (e.g., approximately one nanosecond) because the pulses travel and the speed of light and because the light emission assembly 205 and light detection assembly 250 are separated from the retroreflector 295 by only a small distance (e.g., six inches, ten inches, twelve inches). The representation of time shift in FIG. 4 is not necessarily to scale, i.e., the duration of each pulse and each time interval between pulses is many times larger than the time shift.

In addition to the first delay, though, a larger second delay or time shift between light source 210 activation and measurement of the reflection intensity is attributable to circuitry of the light emission assembly 205 and the light detection assembly 250. Specifically, a drive delay exists between a signal to activate the light source 210 (e.g., to turn on an LED), and a receive delay occurs in the sensor 265 and other elements of the light detection assembly 250. The present disclosure observes that the amount of this second delay (including both drive and receive delays) can be determined a priori based on the involved circuitry and thus, the controller 290 can time a sampling of the measured reflection intensity to occur synchronously with the measurement of peak (or near-peak) reflection via the light detection assembly 250.

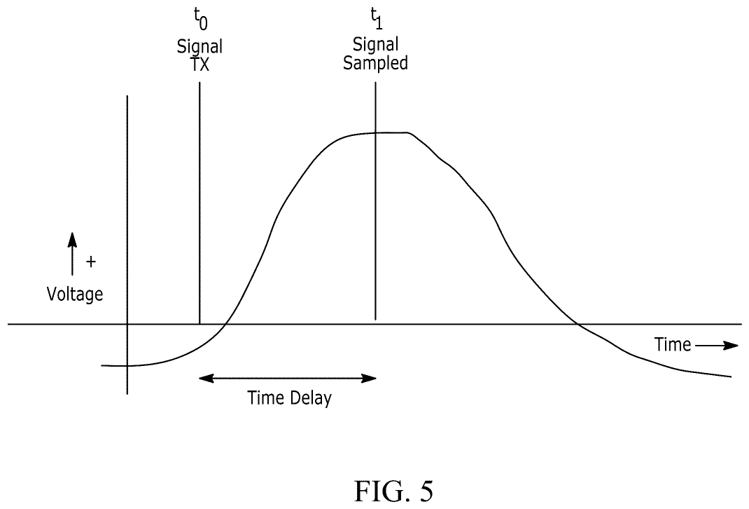

The combination of the above-described delays can be observed with respect to FIG. 5, which depicts time-based voltage sampled by the imaging system 10, where the light detection assembly 250 produces the voltage proportionally to the intensity of the detected reflection. The light emission assembly emits a pulse of the light 215 at a time t₀ (“SIGNAL TX”). From time t₀, no reflection of the light 215 arrives at the light detection assembly 250 for a short time (the first delay for travel of the light 215 to and from the retroreflector 295, e.g., approximately one nanosecond). Thereafter, the reflected light arriving at the light detection assembly 250 increases intensity from zero to a peak amplitude that the imaging system 10 samples at a time t₁, before decreasing to zero once arrival of the reflection is complete. The same pattern repeats for each pulse of the light 215 emitted by the light emission assembly 205. For any pulse, attenuation of the peak reflection intensity (i.e., the measured peak being less than the expected peak, for example by at least a predetermined threshold amount, e.g., 5%, 10%, 20%, etc.) indicates that an object is likely in the path between the light source 210 and the retroreflector 295 (i.e., blocking or scattering at least a portion of the light). When implemented in a bioptic barcode reader, the imaging system 10 can determine an off-platter condition based at least in part on these measurements.

As depicted in FIG. 5, a time delay separates the light emission at t₀ from the sampling of the light at t₁. This time delay includes the light travel delay as well as the circuitry delays of the imaging system 10. This time delay can be determined a priori based on the hardware of the imaging system 10, and accordingly, the imaging system 10 described herein is calibrated to sample the measurement of the reflection intensity when the measured reflection intensity is expected to be at or near its greatest magnitude (e.g., at or near the peak at time t₁), so as to improve the signal-to-noise ratio (SNR) between the emitted light 215 and noise from the environment around the imaging system 10. By calibrating to sample the reflection intensity measurement at only the predetermined time(s) corresponding to expected peak (or near-peak) reflection intensity, the imaging system 10 avoids needing to sample the reflection intensity measurement repeatedly to identify the peak reflection measured for any given pulse, which is particularly beneficial given that the controller 290 is limited in its processing resolution. That is, the controller 290 may, for example, only be capable of sampling the reflection intensity measurement once per 250, 500, 600, 750, or 1000 nanoseconds, and thus is not capable of taking an unlimited number of samples after emission of the pulse to identify a sample that corresponds to peak intensity.

Still referring to FIG. 5 in view of the imaging system of FIGS. 1-3, the light detection assembly 250 may in some embodiments be further configured to manipulate signal characteristics of the received reflection over time, specifically to flatten the peak of the reflection intensity over a longer duration of time. This signal manipulation allows for additional forgiveness in the timing of sampling the reflection intensity, as sampling of the reflection intensity measurement in a time interval in one or more both directions around t₁ would more closely match the reflection intensity at t₁ than would be the case without the signal manipulation.

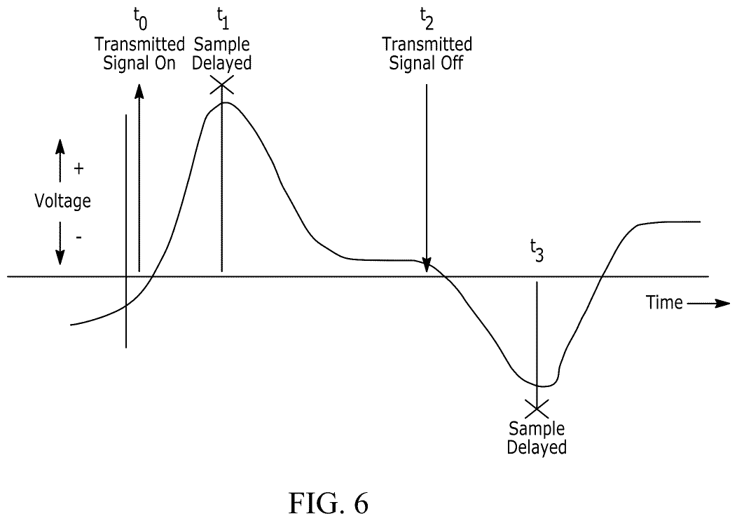

Moving to FIG. 6, still in view of FIGS. 1-3, the imaging system 10 may in some embodiments employ additional techniques to produce a second, negative peak voltage that the controller 290 may sample as a measurement of the reflection intensity. Specifically, the light detection assembly 250 may include a capacitor energized by the receiving of the reflection of the light 215 at the sensor 265. Referring to FIG. 6, upon conclusion of the receiving of the reflection at a time t₂, the capacitor may de-energize over an interval of time, producing a peak negative voltage at still another time t₃. The negative voltage at t₃ may have a same amplitude as the peak reflection intensity at t₁, and as with t₁, the precise timing of t₃ relative to activation of the light emission assembly 205 can be identified a priori. Accordingly, in some embodiments, instead of sampling the voltage at t₁, the controller 290 may sample the voltage at t₃ to determine the peak reflection intensity observed for any given pulse of the light 215. In some embodiments, the controller 290 may sample both the t₁ and t₃ voltages, and average the two samples together to determine the peak reflection intensity observed for any pulse of the light 215.

FIG. 4 is a block diagram representative of an example logic circuit capable of implementing, for example, one or more components of the example systems and methods described herein. Other example logic circuits capable of, for example, implementing operations of the example methods described herein include field programmable gate arrays (FPGAs) and application specific integrated circuits (ASICs). The processing platform 400 may be an example implementation of the imaging system 10. More particularly, the processing platform 400 may be used in or in association with a bioptic barcode reader, and may function for example to detect an off-platter condition with respect to a weigh platter for the bioptic barcode reader.

The example processing platform 400 of FIG. 4 includes a processor 402 such as, for example, one or more microprocessors, controllers, and/or any suitable type of processor. The example processing platform 400 of FIG. 2 includes memory (e.g., volatile memory, non-volatile memory) 404 accessible by the processor 402 (e.g., via a memory controller). The example processor 402 interacts with the memory 404 to obtain, for example, machine-readable instructions stored in the memory 404 corresponding to, for example, the operations represented by the flowcharts of this disclosure. Additionally, or alternatively, machine-readable instructions corresponding to the example operations described herein may be stored on one or more removable media (e.g., a compact disc, a digital versatile disc, removable flash memory, etc.) that may be coupled to the processing platform 400 to provide access to the machine-readable instructions stored thereon.

As an example, the example processor 402 may interact with the memory 404 to access and execute instructions related to and/or otherwise comprising a reflection sampling module 404A capable of sampling measurements of intensity of a reflection of light detected by sensor, as described herein. The reflection sampling module 404A may include instructions that, when executed, cause the processor 402 to obtain samplings of measurements of the reflection intensity at pre-determined times relative to activation of one or more light sources, so as to account for light travel delays and/or circuitry delays in obtaining the reflection intensity measurement. The reflection sampling module 404A may also include instructions that, when executed, cause the processor 402 to compare an obtained reflection intensity measurement to an expected peak intensity, and to determine whether an object is in a path between a light source and a reflector based on the comparison (e.g., based on whether the measured reflection intensity at the pre-determined time is less than the expected peak intensity by at least some amount, such as a predetermined threshold). Still additionally, the reflection sampling module 404A may include instructions that, when executed, cause the processing platform 400 to determine an off-platter condition (or an absence thereof) based on the comparison. Still additionally or alternatively, the reflection sampling module 404A may include instructions that cause the processing platform 400 to perform still other actions described in this disclosure.

illustrated in FIG. 4, an imaging device 406 includes imaging sensor(s) 406A. The imaging sensor(s) 406A may include one or more sensors configured to capture image data corresponding to a target object, an indicia associated with the target object, and/or any other suitable image data. More generally, the imaging sensor(s) 406A may be or include a visual imager (also referenced herein as a “vision camera”) with one or more visual imaging sensors that are configured to capture one or more images of a target object. Additionally, or alternatively, the imaging sensor(s) 406A may be or include a barcode scanner with one or more barcode imaging sensors that are configured to capture one or more images of an indicia associated with the target object. Moreover, a main illumination source 408 may generally be configured to emit illumination during a predetermined period in synchronization with image capture of the imaging device 406. The imaging device 406 may be configured to capture image data during the predetermined period, thereby utilizing the illumination emitted from the illumination source 408.

The example processing platform 400 also includes a network interface 410 to enable communication with other machines via, for example, one or more networks. The example network interface 410 includes any suitable type of communication interface(s) (e.g., wired and/or wireless interfaces) configured to operate in accordance with any suitable protocol(s). For example, in some embodiments, networking interface 410 may transmit data or information (e.g., imaging data and/or other data described herein) between the processing platform 400 and any suitable connected device(s).

In the illustrated example, a POS system 412 is communicatively coupled to the processing platform 400 through the network interface 410. The POS system 412 may be configured to calculate prices of objects to be purchased by users, based on receiving an identification of the object as determined by a product identification system within the processing platform 400 and based on the weight measured by the weigh platter assembly, such as by weigh platter 105. The POS system 412 may include a user interface 414 configured to receive input from users and provide information to users. The POS system 412 may further include one or more processors 416 and a memory 418 (e.g., volatile memory, non-volatile memory) accessible by the one or more processors 416 (e.g., via a memory controller). The one or more processors 416 may interact with the memory 418 to obtain, for example, computer-readable instructions stored in the memory 418. The computer-readable instructions stored in the memory 418, when executed by the one or more processors 416, may cause the one or more processors 416 to monitor the current weight measured by the weigh platter assembly, e.g., based on data sent from the weigh plater 105 via a network 420. Furthermore, the computer-readable instructions stored on the memory 418 may further include instructions for calculating a weight-based price for each object to be purchased based on the identification of the object and the weight measured by the weigh platter assembly. That is, the computer-readable instructions stored on the memory 418 may cause the POS system 412 to access a database listing prices per unit weight for the identified object, and may calculate the price of the object based on the price per weight and the weight at the time when the indication of the identification of object is received.

The processing platform may further include weigh platter assembly 422, e.g., having a weigh platter, and one or more off-platter detection assemblies 424. The weigh platter assembly 422 may monitor the weight of objects placed on a weighing platter associated with the checkout workstation and may continuously or periodically log and send the monitored weights to the POS system 412, e.g., via the network 420.

Each of the one or more off-platter detection assemblies 424 may include a light emission assembly 426 and a light detection assembly 428, which may be examples of the light emission assembly 205 and the light detection assembly 250 of FIG. 3. For simplicity, only a single light emission assembly 426 and only a single light detection assembly 428 are shown and described herein, however, it will be understood that off-platter detection assembly 424 can also include any number and/or type(s) of light emission assemblies, and any number and/or type(s) light detection assemblies may be implemented to detect off-platter condition on different sides of the weigh platter assembly 422. In the illustrated example, the off-platter detection assembly 424 includes a dedicated, low resource processor 430, which may include a memory (not shown), configured to implement operations of the example methods herein.

The example processing platform 400 also includes input/output (I/O) interfaces 432 to enable receipt of user input and communication of output data to the user, for example, on an embedded display 434 within a housing of the imaging system.

FIG. 5 illustrates an example method 500 for determining whether an object is positioned in a path between a light source and a reflector (e.g., to determine an off-platter condition in relation to a bioptic barcode reader), in accordance with embodiments disclosed herein.

The method 500 includes, at a first time, emitting a light beam via a light source to impinge upon a reflector (e.g., retroreflector) positioned distally from the light source (502).

The method 500 also includes receiving a reflection of the emitted light beam via a sensor (504).

The method 500 still further includes, via a controller, obtaining an indication of a predefined measurement delay associated with a detection of a particular intensity of the reflection of the emitted light beam via the sensor (506). The particular intensity may, for example, be a peak intensity of the reflection, and the expected reflection intensity at the second time may accordingly be an expected peak reflection intensity. Alternatively, the particular intensity may be another intensity of the received reflection at a particular point in a waveform phenomenon of the received reflection. The measurement delay may include travel delay of the emitted light itself, and/or circuitry delay of one or more components that emit the light and/or detect the reflection (e.g., drive delay in emitting the light and/or receive delay in measuring the reflection). The controller may store the indication of the predefined measurement delay at a controller memory, in embodiments. Additionally or alternatively, in embodiments, the controller may obtain the indication of the predefined measurement delay via communications over one or more networks.

The method 500 still yet further includes, via the controller, measuring a reflection intensity of the received reflection at a second time identified based on the measurement delay and the first time (508).

The method 500 still further includes, via the controller, comparing the measured reflection intensity to an expected reflection intensity for the second time (510).

The method 500 still yet further includes, via the controller, determining whether an object is positioned in a path between the light source and the reflector based on the comparing of the measured reflection intensity at the second time to the expected reflection intensity.

In some embodiments, the method may further include, via a weigh platter having a surface extending in a transverse plane, measuring a weight of an object on the weigh platter, wherein the light source emits the light beam along the transverse plane. In these embodiments, the method may still further include, via the controller, (1) determining that an object is on the weigh platter based on the measured weight of the object, (2) determining an off-platter condition based on the comparing of the measured reflection intensity to the expected reflection intensity when the object is on the weigh platter, and/or (3) causing a visual indication of the off-platter condition to be provided to a user via one or more output devices.

In some embodiments, the method further includes, via the controller, (1) sampling the reflection intensity by measuring the reflection intensity at a plurality of time intervals after the first time, and (2) using the reflection intensity measured at the second time and not at other ones of the plurality of time intervals to determine whether an object is positioned in the path between the light source and the reflector.

In some embodiments, determining whether an object is positioned in the path is based on determining whether a difference between the measured reflection intensity and the expected reflection intensity is equal to or greater than a nonzero threshold value (e.g., 5% of the expected reflection intensity, 10%, 15%, 20%, 25%, etc.).

In some embodiments, the method further includes, via the controller and in response to determining that an object is positioned in the path between the light source and the reflector based on a difference between the measured reflection intensity and the expected reflection intensity, determining a further one or more properties of the object based on the difference. For example, a composition or identification of the object may be determined based upon an amount of the reflection that is attenuated by the light passing through the object. This technique may be used, for example, to determine the density, viscosity, and/or other properties of a liquid, where the liquid is positioned between the light source and the reflector.

In some embodiments, the method further includes (1) energizing a capacitor using energy from the receiving of the reflection of the emitted light beam, and (2) de-energizing the capacitor after the receiving of the reflection. The second time may particularly be a time associated with an expected negative voltage (e.g., peak negative voltage) during the de-energizing of the capacitor, and wherein the measuring of the reflection intensity is based on measuring a negative voltage of the capacitor at the second time.

In some embodiments, the measured reflection intensity is a measurement of an intensity of a particular one of two or more wavelengths of light contained in the reflection and/or in the emitted light.

The method 500 may include additional, fewer, and/or alternate actions, in various embodiments. Moreover, it should be appreciated that the order of actions in the method 500 may, in embodiments, occur in orders other than that in which the actions were described in the foregoing.

### Additional Considerations

In the foregoing specification, specific embodiments/aspects have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations/aspects should not be interpreted as mutually exclusive, and should instead be understood as potentially combinable if such combinations are permissive in any way. In other words, any feature disclosed in any of the aforementioned embodiments, examples, implementations, or aspects may be included in any of the other aforementioned embodiments, examples, implementations, or aspects.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed is:

1. A system comprising:
a light source configured to emit a light beam at a first time to impinge upon a reflector positioned distally from the light source;
a sensor configured to receive a reflection of the emitted light beam from the reflector; and
a controller configured to:
(i) obtain an indication of a predefined measurement delay associated with a detection of a particular intensity of the reflection of the emitted light beam via the sensor,
(ii) measure a reflection intensity of the received reflection at a second time identified based on the measurement delay and the first time,
(iii) compare the measured reflection intensity to an expected reflection intensity for the second time, and
(iv) determine whether an object is positioned in a path between the light source and the reflector based on the comparing of the measured reflection intensity at the second time to the expected reflection intensity.

2. The system of claim 1, further comprising a weigh platter having a surface extending in a transverse plane, the weigh platter being configured to measure a weight of an object on the weigh platter,
wherein the light source is configured to emit the light beam along the transverse plane.

3. The system of claim 2, wherein the controller is further configured to (v) determine that an object is on the weigh platter based on the measured weight of the object, and (vi) determine an off-platter condition based on the comparing of the measured reflection intensity to the expected reflection intensity when the object is on the weigh platter.

4. The system of claim 3, wherein the controller is further configured to cause a visual indication of the off-platter condition to be provided to a user via one or more output devices.

5. The system of claim 1, wherein the particular intensity is a peak intensity of the reflection of the emitted light beam, and wherein the expected reflection intensity for the second time is an expected peak reflection intensity.

6. The system of claim 1, wherein the controller stores the indication of the predefined measurement delay at a controller memory.

7. The system of claim 1, wherein the controller is further configured to (v) sample the reflection intensity by measuring the reflection intensity at a plurality of time intervals after the first time, and (vi) use the reflection intensity measured at the second time and not at other ones of the plurality of time intervals to determine whether an object is positioned in the path between the light source and the reflector.

8. The system of claim 1, wherein the controller is configured to determine whether an object is positioned in the path by determining whether a difference between the measured reflection intensity and the expected reflection intensity is equal to or greater than a nonzero threshold value.

9. The system of claim 1, wherein the controller is further configured to, in response to determining that an object is positioned in the path between the light source and the reflector based on a difference between the measured reflection intensity and the expected reflection intensity, the controller is further configured to determine a further one or more properties of the object based on the difference.

10. The system of claim 1, further comprising a capacitor configured to be energized via the receiving of the reflection of the emitted light beam, wherein the controller is configured to cause the capacitor to be de-energized after the receiving of the reflection,
wherein the second time is a time associated with an expected negative voltage during the de-energizing of the capacitor, and wherein the controller is configured to measure the reflection intensity by measuring a negative voltage of the capacitor at the second time.

11. A method comprising:
at a first time, emitting a light beam via a light source to impinge upon a reflector positioned distally from the light source;
receiving a reflection of the emitted light beam via a sensor; and
via a controller:
(i) obtaining an indication of a predefined measurement delay associated with a detection of a particular intensity of the reflection of the emitted light beam via the sensor,
(ii) measuring a reflection intensity of the received reflection at a second time identified based on the measurement delay and the first time,
(iii) comparing the measured reflection intensity to an expected reflection intensity for the second time, and
(iv) determining whether an object is positioned in a path between the light source and the reflector based on the comparing of the measured reflection intensity at the second time to the expected reflection intensity.

12. The method of claim 11, further comprising:
via a weigh platter having a surface extending in a transverse plane, measuring a weight of an object on the weigh platter, wherein the light source emits the light beam along the transverse plane.

13. The method of claim 12, further comprising, via the controller, (v) determining that an object is on the weigh platter based on the measured weight of the object, and (vi) determining an off-platter condition based on the comparing of the measured reflection intensity to the expected reflection intensity when the object is on the weigh platter.

14. The method of claim 13, further comprising, via the controller, causing a visual indication of the off-platter condition to be provided to a user via one or more output devices.

15. The method of claim 11, wherein the particular intensity is a peak intensity of the reflection of the emitted light beam, and wherein the expected reflection intensity for the second time is an expected peak reflection intensity.

16. The method of claim 11, wherein the controller stores the indication of the predefined measurement delay at a controller memory.

17. The method of claim 11, further comprising, via the controller, (v) sampling the reflection intensity by measuring the reflection intensity at a plurality of time intervals after the first time, and (vi) using the reflection intensity measured at the second time and not at other ones of the plurality of time intervals to determine whether an object is positioned in the path between the light source and the reflector.

18. The method of claim 11, wherein determining whether an object is positioned in the path is based on determining whether a difference between the measured reflection intensity and the expected reflection intensity is equal to or greater than a nonzero threshold value.

19. The method of claim 11, further comprising, via the controller and in response to determining that an object is positioned in the path between the light source and the reflector based on a difference between the measured reflection intensity and the expected reflection intensity, determining a further one or more properties of the object based on the difference.

20. The method of claim 11, further comprising:
energizing a capacitor using energy from the receiving of the reflection of the emitted light beam; and
de-energizing the capacitor after the receiving of the reflection,
wherein the second time is a time associated with an expected negative voltage during the de-energizing of the capacitor, and wherein the measuring of the reflection intensity is based on measuring a negative voltage of the capacitor at the second time.
